(19) United States
(12) Patent Application Publication
(10) Pub. No.: US 2016/0107356 A1
(43) Pub. Date: Apr. 21, 2016

(54) Demoulding Unit

(71) Applicant: POLYTEC PLASTICS GERMANY GMBH & CO KG, Lohne (DE)

(72) Inventor: Stefan Seelhorst, Lohne (DE)

(21) Appl. No.: 14/785,172

(22) PCT Filed: Apr. 3, 2014
(86) PCT No.: PCT/EP2014/056641

§ 371 Date: Oct. 16, 2015

(30) Foreign Application Priority Data
Apr. 18, 2013 (DE) 10 2013 207 002.0

(51) Int. Cl. B29C 45/44; B29C 45/26

(52) U.S. Cl. CPC B29C 45/4421; B29C 45/2622

(57) ABSTRACT

A demoulding unit for a pot-like recess of an injection-moulded component is designed in such a way that no parting arises on a bottom side of the injection-moulded component and at least this part of the bottom side can be used as a sealing surface. The demoulding unit has a movable inner demoulding element, a front side of which is used to form the burr-free bottom side. In order to produce projections provided on the inside of the recess, projection demoulding elements are provided. The projection demoulding elements may be moved in a circumferential direction by means of a holding/releasing element during the demoulding.

The invention relates to a demoulding unit for an injection-moulded component comprising a pot-like recess.

In injection-moulded components, such as e.g. cover hoods for automotive engines, pot-like recesses can be provided. Such recesses, which particularly have a cylindrical cross section and are used e.g. as filling openings for liquids such as lubricating oil, are designed in such a manner that, for fixing a closing cap in the recess, the recess comprises projections which e.g. extend inwards on the inner side of the recess, so as to make it possible to fix a closing cap in the recess e.g. in the manner of a bayonet lock. The sealing of the closure cap in the pot-like recess can be effected by a preferably annular bottom member of the recess. By an annular bottom member, there is on the one hand realized the filling opening within the ring and, on the other hand, this bottom member forms an annular sealing surface. Recesses of such a complex design which at the same time shall form a sealing surface for a closure cap arranged in the recess, involve injection-moulded components which are difficult in production. For generating the radially inward projections in the pot-shaped recess, correspondingly designed pushers are required in the dernoulding unit. As a consequence, the annular bottom members of the recess which are at least partially abutted by the sealing member of the closing cap will be left with demoulding burrs on them. Thereby, the sealing function in this surface will be impaired.

It is an object of the invention to provide a demoulding unit for an injection-moulded component comprising a pot-like recess of the above type wherein the demoulding unit shall be designed in such a manner that a burr-free sealing surface, particularly of an annular shape, is formed on a bottom member of the recess.

According to the invention, the above object is achieved by the feature defined in claim 1.

The demoulding unit of the invention is designed for a pot-like recess provided in an injection-moulded component. Particularly, said recess is a substantially cylindrical recess which on an inner side and respectively an inner side wall comprises at least one projection. This projection, preferably extending toward inwards, serves for connection to a closing cap or the like, e.g. by a sort of bayonet lock. Further, said recess comprises a bottom side or bottom surface. This bottom side or surface is at least partially annular so that an inner opening through the annular bottom serves e.g. as a filling opening and at least a part of the bottom side forms a preferably annular sealing surface which in accordance with the invention is burr-free and respectively gap-free.

Such a sealing surface which is burr-free in spite of the existence of a radial projection on the inner wall of the recess will be realized by use of a demoulding unit comprising an inner demoulding element. This demoulding element, adapted to be inserted into and retracted from the recess particularly by shifting, comprises a preferably plane front side. This front side is provided to form that area of the bottom side of the recess which serves as a sealing surface. The front side does not need to form the entire area of the bottom side but should form at least the annular area of the bottom side that serves as a sealing surface.

For generating the at least one projection on the inner side of the recess, the demoulding unit comprises at least one projection demoulding element. This element is arranged on an outer side of the inner demoulding element and particularly can be displaced in a circumferential direction of the inner demoulding element wherein, by displacement of the projection demoulding element, the at least one projection will be released so that the projection demoulding element can then be pulled out from the recess.

For displacement of the at least one projection demoulding element, the outer side of the inner demoulding element has at least one holding/releasing element connected to it. Said holding/releasing element serves, on the one hand, for holding and respectively fixing the at least one projection demoulding element in an injection position in which the projection on the inner side of the recess will be produced. During the demoulding of the injection-moulded component, i.e. when pulling out the demoulding unit from the recess, the holding/releasing element will effect the release of the projection demoulding element so that the latter can be displaced particularly in the circumferential direction of the inner demoulding element and thereby will release at least one projection formed on an inner side of the recess. With the aid of the demoulding unit of the invention, it is thus possible to form a complex recess which on its inner side comprises at least one and preferably a plurality of projections extending radially inwards, and—additionally—to form an annular, gap-free sealing surface on a bottom side of the recess.

In order to realize, in a simple manner, a movement of the at least one projection demoulding element preferably in a circumferential direction, it is preferred that the at least one holding/releasing element comprises an abutment surface arranged at an angle to a surface line of the outer side of the inner demoulding element. Said abutment surface herein is oriented to be inclined in the direction of the projection demoulding element. This has the effect that, when pulling out the inner demoulding element, the inclination of the abutment surface will cause the creation of a free space into which the projection demoulding element can be moved.

Further, it is preferred that, for generating a projection on the inner side of the recess, two projection demoulding elements are provided. These can be arranged particularly between two holding/releasing elements so that, after the inner demoulding element has been pulled out at least partially, the two projection demoulding elements can be shifted apart from each other in circumferential directions due to the oblique abutment surfaces. Thereby, the demoulding of the projection is simplified.

Since, preferably, a plurality of projections are provided on the inner side of the recess, the holding/releasing elements are preferably designed in such a manner that they serve for the release of two projection demoulding elements. For this purpose, according to a preferred embodiment, the holding/releasing element comprises two mutually opposite abutment faces. These, as described above, are preferably arranged at an angle relative to the surface line at an inclination relative to the projection demoulding element. For this reason, it is preferred that the two opposite abutment faces of the holding/releasing element extend toward each other in the direction of the front side of the inner demoulding element and respectively are have a wedge-shaped configuration.

According to a particularly preferred embodiment, a plurality of holding/releasing elements, e.g. four such elements, are arranged on the outer side of the inner dernoulding element. These holding/releasing elements are preferably arranged with regular distribution on the circumference. According to particularly preferred embodiments, respectively two projection demoulding elements are provided between two adjacent holding/releasing elements, each serving to form a projection.

According to the invention, for releasing the—preferably plural—projections provided on the inner side of the recess, the at least one projection dernoulding element will be displaced in a circumferential direction and respectively on a circular path. According to a particularly preferred embodiment, this is performed by a displacement element provided on the outer side of the inner demoulding element. For each projection demoulding element, a separate displacement element can be provided, or, for instance, a common displacement element can be provided for two adjacent projection demoulding elements.

The displacement element cooperates with the at least one projection demoulding element in such a manner that, when the inner demoulding element is being pulled out from the recess, the displacement element will cause a translatory movement of the at least one projection demoulding element. Such a displacement element can be designed e.g. in a manner similar to a slotted guide. In this case, the displacement element comprises e.g. a projection extending radially outward from the outer side of the inner demoulding element, said projection engaging a cutout area and respectively a path provided on the projection demoulding element. Of course, it can &so be provided that the projection is arranged on the projection demoulding element and that the cutout area is arranged in the outer side of the inner demoulding element. Herein, it is preferred that the projection or the cutout area comprises an abutment surface arranged at an angle to a surface line of the outer side of the inner demoulding element. Thus, due to said abutment surface, which can also be formed e.g. by an obliquely oriented slide-guide path, the pull-out movement of the inner demoulding element will be accompanied by a displacement of the projection demoulding element in a circumferential direction. In case that the abutment surface is designed as a slide-guide path, the latter can be preferably configured in such a manner that, when the inner dernoulding element is being pulled out, there will first occur no displacement of the projection demoulding elements and, subsequently, only in the course of the further pull-out movement of the inner dernoulding element, a corresponding displacement of the projection demoulding element will take place. In this manner, jamming is avoided. It is particularly preferred that, when the inner demoulding element is being pulled out from the recess, the at least one projection dernoulding element will carry out a helical movement, i.e. a movement along a helical line. In case that two projection demoulding elements and respectively a plurality of pairs of projection demoulding elements are provided, it is preferred that two helical movements of the projection demoulding elements will occur in opposite senses,

The invention will be explained in greater detail hereunder by way of a preferred embodiment with reference to the accompanying drawings.

In the drawings:

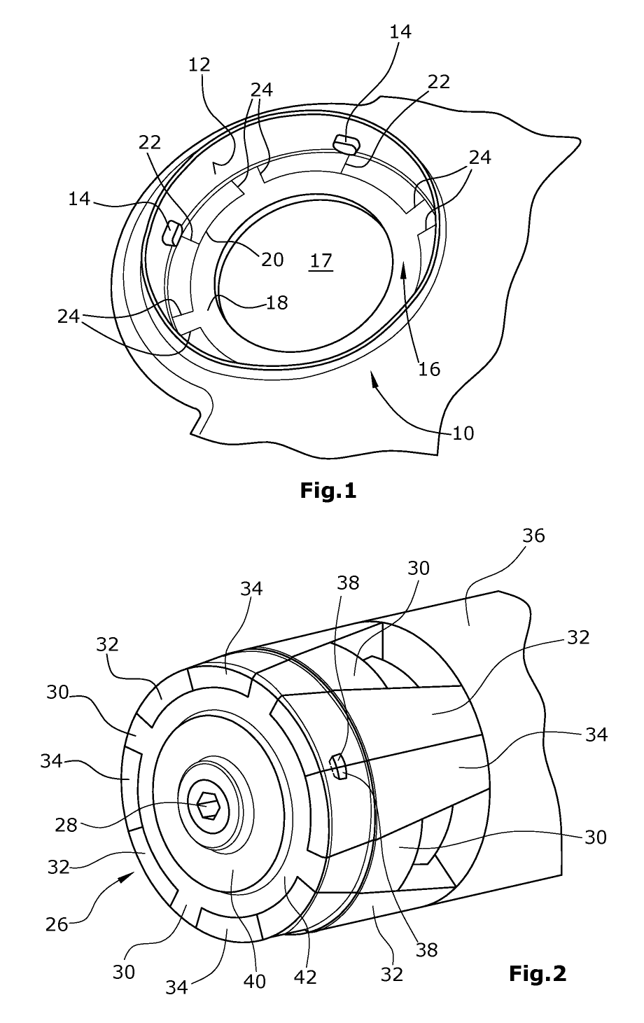

FIG. 1 is a schematic perspective view of a portion of an injection-moulded component comprising a pot-like recess,

FIG. 2 is a schematic perspective view of the demoulding unit,

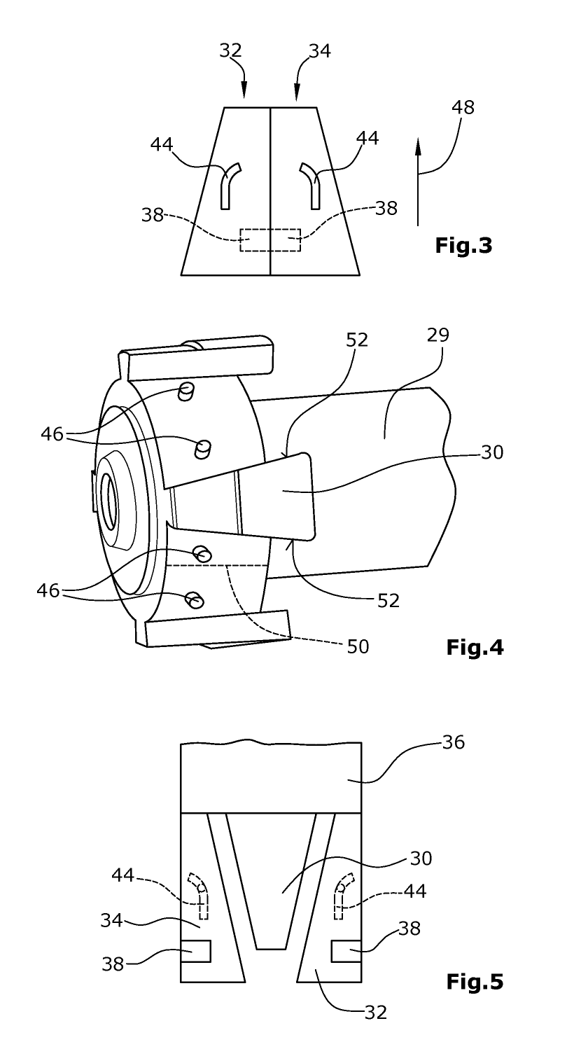

FIG. 3 is a schematic view of an inner side of two adjacent projection demoulding elements,

FIG. 4 is a schematic perspective view of the inner demoulding element, and

FIG. 5 is a schematic lateral view of the demoulding unit during the demoulding process.

An injection-moulded component, which can be e.g. a cylinder head cover, comprises a pot-like recess 10. The pot-like recess 10 substantially has a circular cylindrical shape. On an inner side or inner side wall 12, a plurality of projections 14 are arranged, extending radially inwards and being distributed along the circumference. Said projections 14 serve for holding a closing cap, not shown, e.g. by means of a bayonet lock. A bottom side 16 extends radially inward from inner side 12 and, in the illustrated exemplary embodiment, has an annular shape. The demoulding unit according to the invention makes it possible that an inner annular area 18 will be given a smooth shape and will be burr-free. Said inner annular area 18 is surrounded by an annular, interrupted ridge 20. With the aid of individual pushers and elements of the demoulding unit, further ridges 22,24 will be formed in the inner annular area 18.

For producing a pot-like recess 10, the demoulding unit of the invention (FIGS. 2 to 5) comprises an inner demoulding element 26. The demoulding element 26 can be fixed via a screw 28 to a cylindrical actuating element 29 (FIG. 4) or be integrally connected to it. The inner demoulding element in the illustrated exemplary embodiment comprises four holding/releasing elements 30. In the illustrated exemplary embodiment, respectively two projection demoulding elements 32,34 are arranged each time between the holding/releasing elements 30. Further, the cylindrical member 29 is connected via screw 28 to the actuating element 29. The cylindrical element 29 of the inner demoulding element is surrounded by a holding element 36 (FIG. 2) formed e.g. as a hollow cylinder.

For forming the projections 40 on the inner side 12 of recess 10, two adjacent projection demoulding elements 32,34 comprise a respective cutout 38 into which the plastic for forming the projections 14 will be injected.

For producing the injection-moulded component comprising recess 10, the demoulding unit, while in its closed state (FIG. 2), will be introduced into the injection mould at the respective site where the recess 10 shall be formed. In a next step, the plastic will be injected. In this process, there will be formed particularly the bottom side comprising the filling opening 17, as well as the inner side 12 comprising the - the illustrated exemplary embodiment, four—radial inward projections 14. Herein, by means of a cylindrical projection 40 (FIG. 2), protruding in the longitudinal direction, of inner demoulding element, the opening 17 will be formed in cooperation with the respective injection mould. The burr-free annular area 16 will be formed by the annular area 42 surrounding the projection 40. Said area 16 is joined by the likewise annular area of the plurality of ridges 22,24. This area will be formed by the annular area outside of ring 42. Said ridges 22,24 will be generated along the contacting edges between the two projection demoulding elements 32,34, which contacting edges point in this direction. The ridges 24 are formed by the corresponding edges between the holding/releasing elements 30 and the respective adjacent projection demoulding elements 32,34. In a corresponding manner, the ring-segment-shaped ridges 20 are formed by the edges between ring 42 and the corresponding edges of the projection demoulding elements 32,34.

Demoulding is performed in that, in a first step, the inner demoulding element 26 will—in a first demoulding phase—be pulled out of the recess to some extent. In this first demoulding step, it is preferred that neither the projection demoulding elements 32,34 nor the holding element 36 will be moved. Together with the inner demoulding element 26, the holding/releasing elements fixedly connected thereto will, in the position shown in FIG. 5, be pulled out from recess 10 until the outer sides of the holding/releasing elements will be in abutment on holding element 36.

During this first phase of the demoulding, the projection demoulding elements 32,34—eight of them in this exemplary embodiment—are now held in position by holding element 36 which e.g. can be spring-loaded.

For further demoulding, the shell-shaped holding element will be displaced together with the inner demoulding element. This will cause the projection demoulding elements to be released. These can now be displaced particularly in a circumferential direction. In this exemplary embodiment, a further displacement is performed with the aid of a sort of slotted guide. For this purpose, the inner sides of the projection demoulding elements 32,34 are provided with path-shaped cutout areas 44 which are engaged by respective rods or pins 46. Because of the curvature of path 44, a movement of the pins 46 in the direction marked by arrow 48 (FIG. 3) will cause adjacent projection demoulding elements 32,34 to be moved apart from each other, as shown in FIG. 5.

1. A demoulding unit for an injection-moulded component comprising a pot-like recess, the recess comprising at least one projection on an inner side, said demoulding unit comprising
a movable inner demoulding element having a front side for forming the burr-free bottom side of the pot-like recess,
at least one projection demoulding element arranged on an outer side of the inner demoulding element, and
at least one holding/releasing element connected to the outer side of the inner demoulding element, provided to hold the at least one projection demoulding element in an injection position and to release the at least one projection demoulding element for demoulding by moving the inner demoulding element.

2. The demoulding unit according to claim 1, wherein the holding/releasing element comprises an abutment face arranged at an angle to a surface line and inclined relative to the holding/releasing element.

3. The demoulding unit according to claim 1, wherein two projection demoulding elements are respectively actuated by a common holding/releasing element, the holding/releasing element comprising two opposite abutment faces.

4. The demoulding unit according to claim 3, wherein the two opposite abutment faces extend toward each other in a direction of the front side of the inner demoulding element.

5. The demoulding unit according to claim 1, wherein two projection demoulding elements are arranged between two holding/releasing elements.

6. The demoulding unit according to claim 1, wherein a plurality of holding/releasing elements are arranged on the outer side of the inner demoulding element with even distribution.

7. The demoulding unit according to claim 1, wherein, during demoulding, the projection demoulding elements are moved on a circular line in a circumferential direction.

8. The demoulding unit according to claim 1, wherein the inner demoulding element comprises, on the outer side, a displacement element cooperating with the at least one projection demoulding element in such a manner that, when the inner demoulding element is pulled out from the recess, the displacement element causes a helical movement of the at least one projection demoulding element.

9. The demoulding unit according to claim 8, wherein, when the inner demoulding element is pulled out from the recess, two projection demoulding elements, perform helical movements in opposite directions.

10. The demoulding unit according to claim 8, wherein the displacement element comprises a projection which engages with a cutout area in the projection demoulding element.

11. The demoulding unit according to claim 10, wherein at least one of the projection and the cutout area comprise an abutment surface arranged at an angle to a surface line of the outer side of the inner demoulding element.

12. The demoulding unit according to claim 1, wherein a holding element is provided for holding the at least one projection demoulding element during a first moulding step.

13. The demoulding unit according to claim 6, wherein the plurality of holding/releasing elements comprises four holding/releasing elements.

14. The demoulding unit according to claim 10, wherein the projection on the displacement element extends radially outward.
